(19) United States
(12) Patent Application Publication
(10) Pub. No.: US 2021/0065245 A1
(43) Pub. Date: Mar. 4, 2021

(54) USING MACHINE LEARNING TO DISCERN RELATIONSHIPS BETWEEN INDIVIDUALS FROM DIGITAL TRANSACTIONAL DATA

(71) Applicant: Intuit Inc., Mountain View, CA (US)

(72) Inventors: Yehezkel Shraga Resheff, Jerusalem (IL); Sigalit Bechler, Hod Hasharon (IL); Tzvika Barenholz, Hod HaSharon (IL); Yair Horesh, Kfar Sava (IL)

(73) Assignee: Intuit Inc., Mountain View, CA (US)

(21) Appl. No.: 16/557,958

(22) Filed: Aug. 30, 2019

(51) Int. Cl. G06Q 30/02; G06K 9/62; G06N 20/00; G06F 16/901; G06F 16/9035; G06F 16/9536

(52) U.S. Cl. CPC G06Q 30/0269; G06K 9/6224; G06F 16/9536; G06F 16/9017; G06F 16/9035; G06N 20/00

(57) ABSTRACT

A method including receiving a data structure describing transactions between electronic user accounts associated with users. A relationship graph is constructed from the data in the data structure. The relationship graph has nodes representing entities described in the transactions. The relationship graph has edges representing connections between the nodes. The method also includes clustering groups of nodes within the nodes to form clusters among the nodes. The edges are labeled as relationships types. Labeling is performed by receiving, as input to a machine learning model, a vector having attributes representing the clusters, the nodes, and the edges. Labeling is also performed by outputting, from the machine learning model, probabilities. Each of the probabilities corresponds to a corresponding probability that an edge in the edges represents a relationship type between two nodes in the nodes. Labeling is also performed by labeling, based on the output, the edges as the relationship types.

### BACKGROUND

Computers are increasingly used to track financial information and to handle financial transactions between individuals. For example, it is increasingly common to transfer money between individuals and organizations using software applications. Over time, a vast amount of financial transaction data is stored on computers.

### SUMMARY

In general, in one aspect, one or more embodiments relate to a method. The method includes receiving a data structure comprising data describing a plurality of transactions between electronic user accounts associated with a plurality of users. The method also includes constructing a relationship graph from the data in the data structure. The relationship graph comprises a plurality of nodes representing a plurality of entities described in the plurality of transactions. The relationship graph further comprises a plurality of edges representing a plurality of connections between the plurality of nodes. The method also includes clustering groups of nodes within the plurality of nodes to form a plurality of clusters among the plurality of nodes. The method also includes labeling the plurality of edges as a plurality of relationships types. Labeling is performed by receiving, as input to a machine learning model, a vector comprising attributes representing the plurality of clusters, the plurality of nodes, and the plurality of edges. Labeling is also performed by outputting, from the machine learning model, a plurality of probabilities. Each of the plurality of probabilities corresponds to a corresponding probability that an edge in the plurality of edges represents a relationship type between two nodes in the plurality of nodes. Labeling is also performed by labeling, based on the output, the plurality of edges as the plurality of relationship types.

One or more embodiments also relate to a system. The system includes a computer processor. The system also includes a data repository storing a data structure comprising data describing a plurality of transactions between electronic user accounts associated with a plurality of users. The data repository also stores a relationship graph. The relationship graph comprises a plurality of nodes representing a plurality of entities described in the plurality of transactions. The relationship graph further comprises a plurality of edges representing a plurality of connections between the plurality of nodes. The data repository also stores a plurality of clusters among the plurality of entities, and a plurality of relationship types. The system also includes a graph generator executing on the computer processor and configured to build the relationship graph from the data in the data structure. The system also includes a cluster generator executing on the computer processor configured to cluster groups of entities within the plurality of entities to form the plurality of clusters among the plurality of entities. The system also includes a machine learning model trained to label the plurality of edges according to the plurality of relationships types based on the plurality of clusters, the plurality of nodes, and the plurality of edges.

One or more embodiments also relate to another method. The method includes receiving a data structure comprising data describing a plurality of transactions between electronic user accounts associated with a plurality of users. The method also includes constructing a relationship graph from the data in the data structure. The relationship graph comprises a plurality of nodes representing a plurality of entities described in the plurality of transactions. The relationship graph further comprises a plurality of edges representing a plurality of connections between the plurality of nodes. The method also includes clustering groups of nodes within the plurality of nodes to form a plurality of clusters among the plurality of nodes. The method also includes labeling the plurality of edges as a plurality of relationships types. Labeling is performed by receiving, as input to a machine learning model, a vector comprising attributes representing the plurality of clusters, the plurality of nodes, and the plurality of edges. Labeling is also performed by outputting, from the machine learning model, a plurality of probabilities. Each of the plurality of probabilities corresponds to a corresponding probability that an edge in the plurality of edges represents a relationship type between two nodes in the plurality of nodes. Labeling is also performed by labeling, based on the output, the plurality of edges as the plurality of relationship types. The method also includes performing a computerized action based on the plurality of relationship types, the computerized action comprising one of: a computerized security action and electronic transmission of an electronically actionable message.

Other aspects of the invention will be apparent from the following description and the appended claims.

### BRIEF DESCRIPTION OF DRAWINGS

FIG. 1 depicts a schematic system diagram, in accordance with one or more embodiments.

FIG. 2A and FIG. 2B depict flowchart diagrams, in accordance with one or more embodiments.

FIG. 3 and FIG. 4 depict transactions between electronic accounts, in accordance with one or more embodiments.

FIG. 5 depicts an initial relationship graph constructed from the transactions shown in FIG. 3, in accordance with one or more embodiments.

FIG. 6 and FIG. 7 depict a table of nodes and edges for the relationship graph shown in FIG. 5, in accordance with one or more embodiments.

FIG. 8 depicts a relationship graph with edges among the nodes labeled according to relationship types between the nodes, in accordance with one or more embodiments.

FIG. 9 depicts a table of labeling for edges among nodes in the relationship graph shown in FIG. 8, in accordance with one or more embodiments.

FIG. 10 depicts an actionable electronic message, in accordance with one or more embodiments.

FIGS. 11A and 11B depict a computer system and network in accordance with one or more embodiments

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to techniques for automatically building a relationship graph from financial transaction data, and then labeling edges between nodes in the relationship graph by relationship type. In the past, it was not possible to build a relationship graph with edges defining hidden relationships. In other words, it was not possible to build a relationship graph having edges that defined relationships not directly or explicitly supported by the underlying data. The one or more embodiments address the technical challenge of using computers to automatically label the edges between the nodes by relationship type when the relationships are not explicitly described in the underlying financial transaction data. The one or more embodiments address this technical challenge by identifying entities in the underlying financial transaction data, constructing edge relationships among the nodes using the financial transaction data, clustering the nodes by graph analytics techniques, and then labeling the edges by relationship type through the application of machine learning. Specifically, a machine learning algorithm predicts relationship types based on relationship behavior inferred or predicted from the underlying financial transaction data. Automatic computer actions, such as taking a computerized security action or transmitting an electronically actionable message, can then be taken based on the automatically discerned relationship labels according to pre-defined rules or policies. Thus, the one or more embodiments provide for a technical ability to automatically discern hidden relationships in underlying data and then act on those relationships.

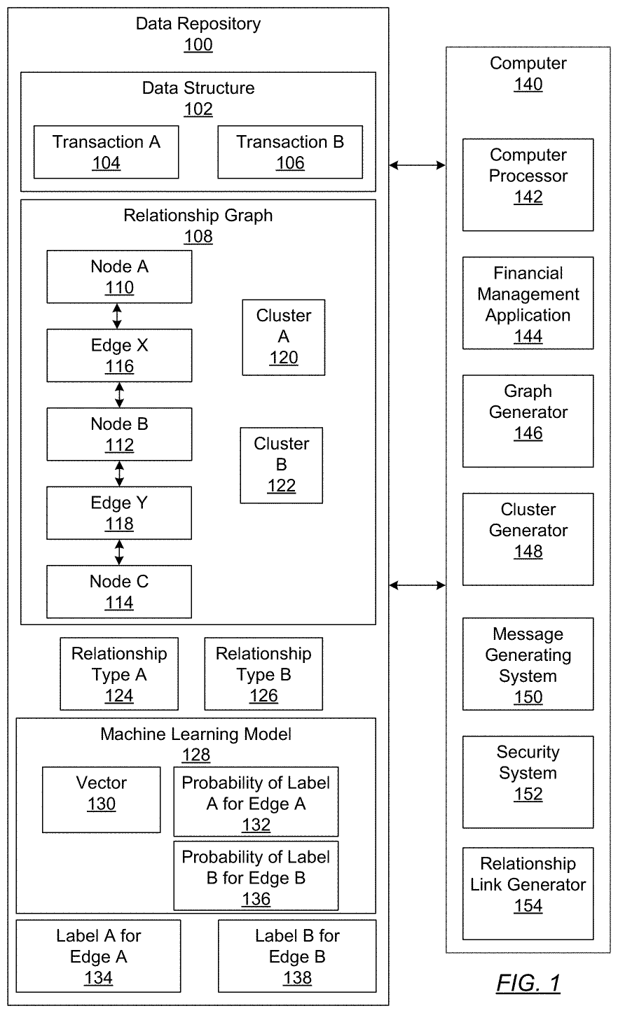

FIG. 1 depicts a schematic system diagram, in accordance with one or more embodiments. The system shown in FIG. 1 may be implemented as hardware, software, or a combination thereof.

The system shown in FIG. 1 includes a data repository (100). In one or more embodiments, the data repository (100) stores a number of files and other information. In general, a data repository (100) is a storage unit (e.g., database, file system, or other storage structure) and/or hardware or virtual device (e.g., non-transitory computer readable storage medium, memory, storage server, etc.) for storing data. The data repository (100) may include multiple homogeneous or heterogeneous storage units or devices.

In one or more embodiments, the data repository (100) includes a data structure (102), which may be maintained in a computerized format for organizing, managing, and storing data. The data structure (102) includes data values and may include metadata, such as the relationships among the data values and the functions or operations that can be applied to the data. Examples of data structures include arrays, linked lists, records, unions (such as tagged unions), objects, graphs, trees, b-trees, and others.

Continuing with FIG. 1, in one or more embodiments, the data structure (102) may also include one or more transactions between electronic user accounts associated with two or more users. Thus, for example, the data structure (102) may include Transaction A (104) and Transaction B (106). Each transaction may include a variety of data, such as but not limited to one or more identifiers for each party to the transaction, the account numbers of the electronic user accounts, dollar amounts, dates, time stamps, and other such information.

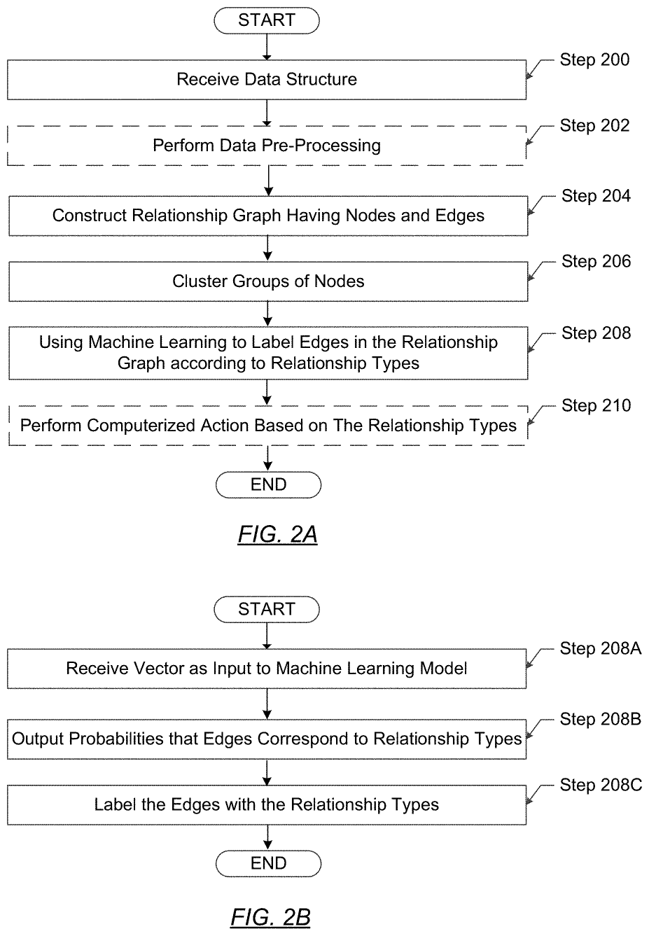

However, the one or more embodiments contemplate that the data in the transactions (i.e., Transaction A (104) and Transaction B (106)) do not include relationship information with respect to the users associated with the electronic user accounts. For example, Transaction A (104) might include the following transaction information: that a payment was sent from a first user account to a second user account on Jan. 1, 2019 for $88.50 at 11:57 a.m. However, at least initially, there is no data in the data structure (102) which directly describes the relationship between the first user and the second user. Nevertheless, the one or more embodiments contemplate that sufficient information is stored in the data structure (102) that such a relationship might be inferred using a machine learning model (128) applied to many such transactions. The operation of the machine learning model (128) is described further below with respect to FIG. 2B.

In one or more embodiments, the data repository (100) also includes a relationship graph (108). The relationship graph (108) also may be characterized as a network graph database, a taxonomy graph, a hierarchical graph, or a tree graph. Regardless of nomenclature, the relationship graph is a set of two or more nodes connected by one or more edges. A node is an entity within the transactions stored in the data structure (102). An edge is a relationship between two nodes. Together, the set of nodes and edges may be a relationship graph, such as but not limited to a directed acyclic graph (DAG), a tree graph, a forest, a directed tree, a singly connected network, and the like. Specific examples of a relationship graph are shown in FIG. 5 and FIG. 8.

Again, each node is an entity. Examples of entities include electronic user account identifiers, usernames, and others. In one or more embodiments, nodes have a number of attributes. Examples of node attributes include the number or frequency of transactions, the number of other entities with which the node interacts, user identifiers, user data, time stamps, data creation dates, and possibly many other types of information.

As indicated above, each edge is a relationship between at least two entities. Edges may be transactions if nodes are usernames or electronic bank account numbers. In another example, edges may be assigned another set of attributes, such as but not limited to a dollar amount of a transaction, a statistical value based on aggregated amounts of multiple financial transactions (i.e., median, mean, average, etc.), transaction texts, dates, direction (i.e., who pays whom), whether the transaction is typical, atypical, recurring, solitary, of fixed or variable sum, etc.

Edges may be labeled with a relationship between users or electronic accounts. For example, an edge could indicate that two users are related as father and child, or that one electronic account is subordinate to another electronic account. Initially, such data is not in the data structure (102). However, such data may be added to the data structure (102) and to the relationship graph (108) after being predicted by a machine learning model, as described further below.

Note that the one or more embodiments contemplate that, in many cases, the type of relationship between two users or two electronic accounts cannot be directly known from the data in the data structure (102). The one or more embodiments contemplate identifying and applying such labels to edges, as described further below with respect to FIG. 2A and FIG. 2B.

The one or more embodiments also contemplate that not all nodes in the relationship graph (108) may be connected. For example, it is expected that the relationship graph (108) will be a disjointed structure of multiple trees, as not all users or electronic accounts will ultimately be connected to each other. Thus, the relationship graph (108) may be a disjointed tree graph.

In the example shown in FIG. 1, the relationship graph (108) includes Node A (110), Node B (112), and Node C (114). Node A (110) is connected to Node B (112) via Edge X (116). In turn, Node B (112) is connected to Node C (114) via Edge Y (118). In each case, the edge indicates a relationship between two nodes. For example, if Node A (110) was “Alice” and Node B (112) was “Bob”, then Edge X (116) could be “$500 from Alice (Node A (110)) to Bob (Node B (112)) on Dec. 31, 2019 at 11:59 p.m.

In one or more embodiments, the relationship graph (108) includes additionally metadata in the form of global attributes that describes the relationship graph (108) itself. For example, the global attributes may include a number of nodes in the graph, a number of edges in the graph, a maximum amount of money ever transacted as an edge in the graph, a last temporal change to the relationship graph, and identification of recurring relationships between nodes that stopped after a certain date. Many other attributes for the relationship graph (108) are contemplated.

In one or more embodiments, a quantitative scale may be applied to the relationship graph (108). The scale represents how closely similar or how different entities are, relative to each other. Any two nodes within the relationship graph (108) may have a distance between them. In other words, an “edge” may have a “length”; however, even nodes not connected by edges may have a numerical distance between them. The greater the length, the more dissimilar the two entities, or nodes. For example, the node “Bob” could be close to “Alice” on the relationship graph, because Bob and Alice engage in frequent financial transactions. Thus, in one or more embodiments, the numerical distance on the relationship graph (108) between “Bob” and “Alice” is small compared to the numerical distance on the relationship graph (108) between “Bob” and “Carl,” with whom there is only one transaction.

Because a scale may be applied to the relationship graph (108), the relationship graph (108) may also include one or more clusters. In the example shown in FIG. 1, the relationship graph (108) may be characterized by two clusters: Cluster A (120) and Cluster B (122). In one or more embodiments, a cluster is a group of two or more nodes that are within a pre-defined distance of each other in the relationship graph (108). The pre-defined distance may be set by a programmer or may be determined automatically by rules or policies. The process of creating clusters in a relationship graph is described with respect to FIG. 2A.

Clusters need not be node-exclusive. In other words, two clusters could have the same node or nodes, though each cluster would have other nodes which were different. In the example shown in FIG. 1, Cluster A (120) could include Node A (110) and Node B (112), whereas Cluster B (122) could include Node A (110), Node B (112), and Node C (114). Many combinations of nodes may be contemplated for any given cluster.

In one or more embodiments, the data repository (100) also includes relationship types stored as data, such as Relationship Type A (124) and Relationship Type B (126). A relationship type is a characterization, stored as electronic data, of a non-obvious relationship between two nodes. The term “non-obvious relationship” means that the relationship between two nodes is not instantly ascertainable by reference to the data structure (102). Thus, a relationship type may be information beyond the information provided by the data structure (102). Most generally, a “relationship type” is any information describing the relationship between nodes in the relationship graph (108) that is derived via a machine learning model, such as machine learning model (128).

For example, assume an electronic transaction of $20 between a first electronic user account and a second electronic user account user. Node A (110) is the first electronic user account and Node B (112) is the second electronic user account. The edge X (116) is a “payor/payee” relationship between Node A (110) and Node B (112). However, a relationship type between these two nodes could be “parent/child”; i.e., the user associated with the first electronic account is the parent of the user associated with the second electronic account. This parent-child relationship between the two users associated with the two electronic accounts is not immediately apparent from the transaction but could be discerned by machine learning from observing transactions over time. The transactions observed need not be between the two users themselves. The one or more embodiments contemplate that many different pre-defined relationship types are stored in the data repository (100).

Continuing with FIG. 1, the data repository (100) may also include the machine learning model (128). Generally, a machine learning model is the definition of one or more mathematical formulas with a number of parameters that are to be learned from underlying data.

In one or more embodiments, the machine learning model (128) could be many different types of machine learning models. The machine learning model (128) may be a supervised machine learning model, a semi-supervised machine learning model, or an unsupervised machine learning model. Specific examples of machine learning models that could be used include a random forest model (which may be of 1500 trees or more), an XGBoost model (which may be defined by 100 iterations with a gamma of 0.001), and a logistic regression model (which may be assigned a penalty of L2). The process of using a machine learning model to infer relationship types among nodes is described with respect to FIG. 2B.

The input for the machine learning model (128) may be a vector (130). A vector (130) is a table of electronic data. A vector (130), for example, could be a series of data types with associated values set to “1” or “0.” For example, a data type might be “transaction direction,” with a value of “1” indicating that an entity associated with the transaction is the payor and a value of “0” indicating that the entity associated transaction with the payee. In a real application, a vector (130) may be a large, multi-dimensional data set which reflects the data harvested from the data structure (102).

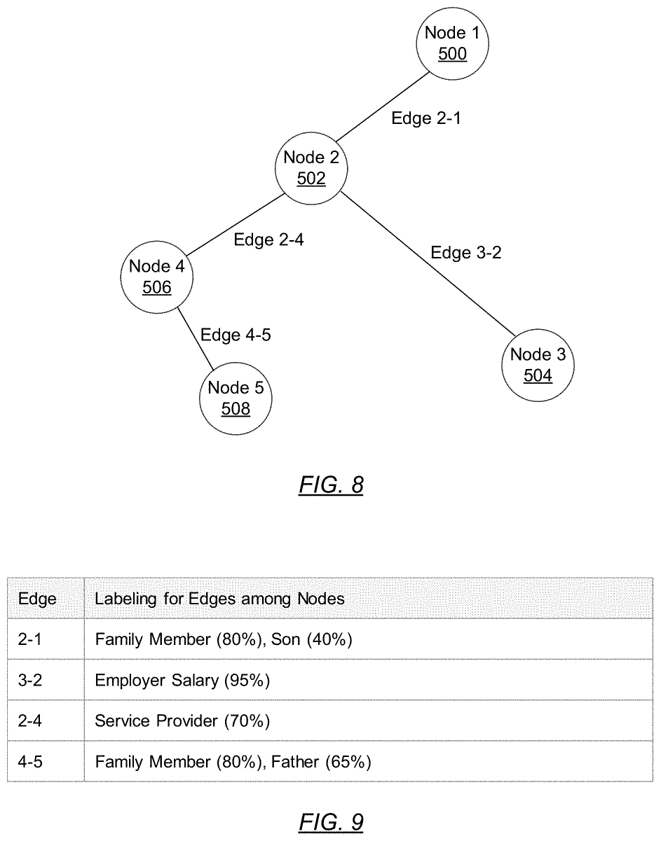

The output of the machine learning model (128) may be probabilities that pre-defined labels apply to edges in the relationship graph (108). Thus, for example, there could be a probability (132) of label A for edge A (134) and a probability (136) of label B for edge B (138). The label A for edge A (134) and the label B for edge B (138) are the relationship types according to which the edges in the relationship graph (108) are labeled. For example, label A for edge A (134) could be either Relationship Type A (124) or Relationship Type B (126), or both, and may be associated with any of the edges in the relationship graph (108), such as Edge X (116). The probability, in turn, represents the machine-learning predicted probability that the associated label is correct. This process is described further with respect to FIG. 2B, and a specific example of this process is described with respect to FIG. 8 and FIG. 9.

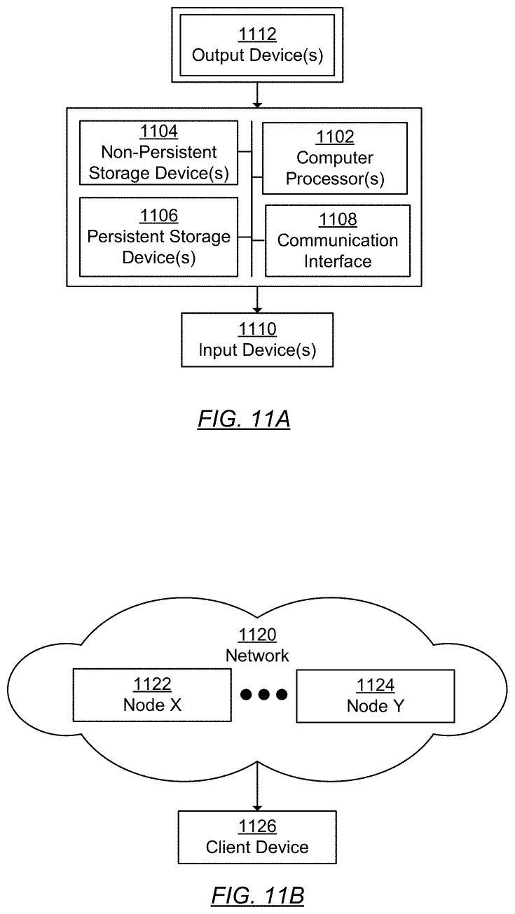

In one or more embodiments, the system shown in FIG. 1 also includes a computer (140). The computer (140) may be one or more computers in a possibly distributed environment, such as shown in FIG. 11A and FIG. 11B. One or more processors, such as a computer processor (142), executes the machine learning model and executes any instructions used in accomplishing the techniques described with respect to FIG. 2B through FIG. 9.

In one or more embodiments, the computer (140) is one or more server computers which are also used to operate a financial management application (144). A financial management application (144) is hardware and/or software which is used by users to manage financial information and/or perform electronic transactions in a possibly distributed computing environment.

The financial management application (144) is typically a separate code base than the other software components shown in FIG. 1. However, in one or more embodiments, a single organization controls the financial management application (144), the computer (140), and the data repository (100).

Alternatively, such information could be imported form or controlled by one or more other sources in a single location or multiple locations.

In any case, the data structure (102) in the data repository (100) may be derived from raw data describing transactions and other financial information that are stored by or otherwise available to the financial management application (144). The data structure may also be derived from other data sources, such as but not limited to bank records, possibly in conjunction with the financial management application (144).

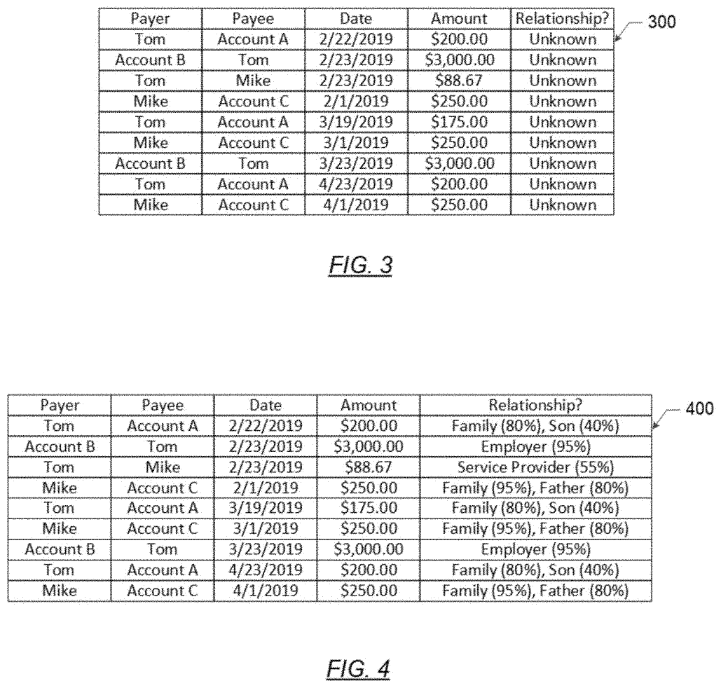

The computer (140) also may be programmed to execute a graph generator (146). A graph generator is hardware and/or software which is configured or programmed, when executed on a computer processor (142), to create the relationship graph (108) from the data contained in the data structure (102). The process of building the relationship graph (108) from the data structure (102) is described further with respect to FIG. 2A, with specific examples given in FIG. 3 through FIG. 9.

The computer (140) also may be programmed to execute a cluster generator (148). A cluster generator (148) is hardware and/or software which is configured or programmed, when executed on a computer processor (142), to create Cluster A (120), Cluster B (122), or other clusters from the data structure (102) and/or the relationship graph (108). The process of building the clusters from the data structure (102) and/or the relationship graph (108) using the cluster generator (148) is described further with respect to FIG. 2A, with specific examples given in FIG. 3 through FIG. 9.

The computer (140) also may be programmed to execute a message generating system (150). A message generating system (150) is hardware and/or software which is configured or programmed, when executed, to create a message to be sent to another computer via a communication interface, such as communication interface (1008) of FIG. 11A.

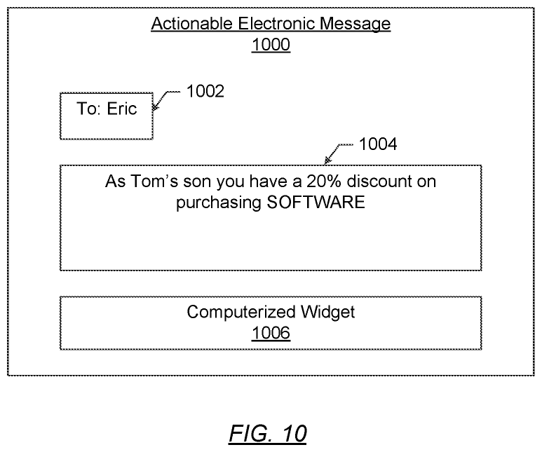

As used herein, a “message” is an electronic message which contains computer useable code or a link to computer usable code which permits a user to take a further computerized action. For example, a message may be an advertisement with a link which will navigate the user's web browser to a page which contains more information regarding a product, or to a window which prompts the user to engage in an electronic financial transaction. The process of creating and transmitting a message using the message generating system (150) is described further with respect to FIG. 2A, with a specific example given in FIG. 10.

The computer (140) also may be programmed to execute a security system (152). The security system (152) is hardware and/or software which is configured, when executed on a computer processor (142), to take a security action relative to at least one user account belonging to at least one of the first entity and the second entity. The security system (152) may be programmed to take action when an entity in a group of entities has a first type of relationship label with another entity in the group of entities. In other words, if the relationship label matches a pre-determined type; i.e., if the relationship label is “fraud”, then the security system (152) takes action. The action may many possible computer-implemented actions, as described with respect to FIG. 2A.

The computer (140) also may be programmed to execute a relationship link generator (154). The relationship link generator (154) is hardware and/or software which is configured or programmed, when executed on a computer processor (142), to link two or more user accounts in an electronic social networking environment. For example, the electronic accounts of two users could be linked by the relationship link generator (154) in order to indicate that the two users are friends, colleagues, family members, or as having some other relationship with each other, such as but not limited to a client-professional relationship, a customer-business relationship, a subordinate-supervisor relationship, etc. The process of linking electronic user accounts using the relationship link generator (154) is described further with respect to FIG. 2A, with specific examples given in FIG. 3 through FIG. 9.

FIG. 2A depicts a flowchart diagram, in accordance with one or more embodiments. The method shown in FIG. 2A may be performed using the system shown in FIG. 1. The method shown in FIG. 2A may also be performed using the system and network shown in FIG. 11A and FIG. 11B. The method shown in FIG. 2A is performed by a computer, such as computer (140) shown in FIG. 1.

At step 200, a data structure is received, which may be data structure (102) shown in FIG. 1, and thus includes data describing transactions between electronic user accounts associated with different users. The data structure (102) may be received via a communication device from one or more data repositories containing many financial transactions of many users. The one or more embodiments contemplate that the financial transactions may be retrieved from or sent by a financial management application (FMA), such as financial management application (144) of FIG. 1. Alternatively, or in some cases in addition to receiving data from the FMA (142), data may be received from or sent by electronic credit card accounts, electronic bank accounts, or other kinds of electronic accounts.

Optionally, at step 202, data pre-processing may be performed. Data pre-processing may take the form of removing stop words (i.e., common words that do not add meaning, such as “the” or “an”), removing duplicative alphanumeric strings within a given transaction, removing any data that is not of interest (e.g., information not relevant to the transaction, electronic user accounts, or the users), adding metadata discerned from sources other than the transaction (e.g., timestamps, user identification, and the like), and re-organizing data into different forms or patterns. Data pre-processing may also include removing any transactions that do not involve at least two different user accounts belonging to at least two different users.

For example, irrelevant data can be removed from the data structure, and then the data structure could be reorganized to fit the following pattern, for each transaction: “user_id,” “date”, “amount”, and “description”. However, many other arrangements of data structures or vectors are contemplated. A pre-determined selection of entries for the “description” may be arranged, or free text or natural language terms may be used in the “description.”

At step 204, after the data structure is considered ready for use at either step 200 or step 202, a relationship graph having nodes and edges is constructed from the data in the data structure in accordance with one or more embodiments. Briefly, the relationship graph is constructed by establishing entities in the data structure as nodes and by establishing edges in the data structures as known interactions between the entities.

Thus, for example, usernames and electronic bank account identifiers can be established as nodes. In this case, the edges in the relationship graph become transfers between the users and the electronic bank accounts. Alternatively, the nodes may be electronic bank accounts, in which case the edges may be transfers between the bank accounts. In an embodiment, the entities may be customers of the FMA, identified as such by metadata, and outside individuals who are not users of the FMA, also identified as such by metadata. In this case, the transactions form the edges between the nodes that are the customers and outside individuals.

From a technical perspective, individuals or electronic bank accounts may be linked based on an account number signature in the “description” string in the example described above. If the signature matches an account number, or part thereof, of an existing user of the FMA, then the existing user (a first entity) and another user (a second entity who may or may not be a user of the FMA) are linked via an edge. However, entities may be linked by other means or using other information; thus, this example does not necessarily limit other possibilities contemplated by the one or more embodiments.

At step 206, after constructing the relationship graph, groups of nodes are clustered in accordance with one or more embodiments of the invention. In this manner, one or more groups of clusters are formed, with each cluster containing one more nodes. Usually, a cluster includes more than one node; however, it is possible that a cluster includes only a single node.

Clustering of nodes may be performed using graph analytical tools to calculate statistical measures of centrality among nodes in the relationship graph. Available graph analytical tools may be used to perform clustering, such as TIGERGRAPH®. The graph analytical tools may be used to identify cliques, communities, and other connected components among the nodes. As a result, clustering creates sub-groups of nodes, such as but not limited to sub-groups of users and sub-groups of electronic accounts.

In a specific example, clustering may be used to extract a sub-cluster within the relationship graph. In this case, a measure of centrality within the sub-cluster may be used to determine a position of an entity within the sub-cluster. In turn, the position of the entity within the sub-cluster may be useful information to provide to a machine learning model in order to help determine a non-obvious relationship type between an entity and other entities in the sub-cluster.

Thus, clustering groups of nodes at Step 206 generates useful information which can be included in a vector to be fed as input to a machine learning model. Specifically, the clustering identifies hidden data or data relationships that can be placed into the data vector that ultimately is fed into the machine learning model. In turn, the machine learning model is then used to predict relationship types between nodes (see step 208 below). Stated differently, edge labeling is based off of clustering in that clustering is used to create the data vector, and the data vector is fed as input to a machine learning model that outputs a prediction which corresponds to the edge labeling.

The clustering of nodes (which is semantically a detection of users with a relationship) results in a list or table of pairs of users that are seen to be related via their transaction behavior. These pairs are an exhaustive list of couples of nodes in the component that are connected themselves. The one or more embodiments automatically give these links names. The names can be either informative relationships (parent-child, couple, etc.) if a supervised learning framework is used, or just similarity based (type-1, type-2, etc.) if unsupervised learning is used to group these relationships into similar categories.

In the supervised learning case a labeled dataset is desired, with examples of pairs of users and the appropriated relationship that they have. The input to the learning algorithm is the features of their transactional behavior (what, when, how much), but also the features of other individuals in the same cluster in the graph that the pair is derived from (like how large the component is, how connected, etc.). In this manner, clustering helps produce features (attributes) of the vector fed to the machine learning model. Accordingly, ultimately, clustering helps to establish edge labeling.

Next, at step 208, machine learning is used to label edges in the relationship graph according to relationship types in accordance with one or more embodiments. The techniques for using machine learning to label edges in this manner are described in further detail with respect to FIG. 2B.

Optionally, at step 210, after the edges have been labeled according to relationship types, a computerized action is performed based on the relationship types in accordance with one or more embodiments. For example, for all users (nodes) having an edge relationship as “family members” where one of the nodes is not a user of the FMA, a computerized message could be transmitted to the non-users of the FMA. In other words, responsive to a first entity having a first type of relationship label with respect to a second entity, an actionable electronic message is transmitted to at least one of the first entity and the second entity. The computerized message could include an actionable electronic code or links, such as hyperlinks which take a recipient of the message to an advertisement for the FMA or to a web page where the FMA can be downloaded. Alternatively, electronic code could be embedded in the computerized message which allows a non-FMA user access to a specialized function of the FMA with respect to the FMA user. The actionable electronic message may include a hyperlink to a web page offering a product for sale. The product may be a software product downloadable to a computing device of at least one of the users. Many different types of actionable electronic codes, links, or widgets are contemplated.

The computerized action taken may be some action other than advertising-related functions. For example, responsive to a first entity having a first type of relationship label with respect to a second entity, a security action can be taken relative to at least one user account belonging to at least one of the first entity and the second entity. An example of a security action includes freezing electronic activity with respect to the at least one user account. Another example of a security action could be to issue an alert to one or more users, or possibly third party users, or possibly to a financial institution responsible for the corresponding electronic user accounts. Many different security actions are contemplated.

The computerized action could also be used in a social network environment to accomplish relationship link generation. For example, when the electronic user accounts are social media accounts, then responsive to a first entity having a first type of relationship label with respect to a second entity, an actionable electronic message can be transmitted to a third entity in the plurality of entities. The third entity has an edge to the second entity but not the first entity. In this case, the actionable electronic message may be an invitation to the third entity to establish an online social connection with the first entity. The actionable electronic message could also be a request to add information to a timeline of one of the users, or a request to display information regarding the first and second users on the third party's social media account. Many different social media actions are contemplated.

FIG. 2B depicts a flowchart diagram, in accordance with one or more embodiments. The method shown in FIG. 2B shows further detailed in step 208 of FIG. 2A, which is using machine learning to label edges in the relationship graph according to relationship types. The method shown in FIG. 2B may be performed using the system shown in FIG. 1. The method shown in FIG. 2B may also be performed using the system and network shown in FIG. 11A and FIG. 11B. The method shown in FIG. 2B is performed by a computer, such as computer (140) shown in FIG. 1.

At step 208A, a vector is received as input to the machine learning model in accordance with one or more embodiments. The vector may be the data received at step 200 or, optionally, pre-processed data from step 202 after data pre-processing. The vector may be the set of nodes and edges, as well as other attributes, of the relationship graph created between step 200 and step 206 of FIG. 2A. Specifically, the vector may contain information derived from clustering, as described above at step 206 of FIG. 2A. The vector more specifically includes attributes representing the clusters, the nodes, and the edges.

At step 208B, the machine learning model outputs probabilities that edges correspond to relationship types in accordance with one or more embodiments. The relationship types are pre-determined by the software engineer or may be retrieved from a data repository.

The machine learning model may be programmed to be an unsupervised, supervised, or semi-supervised machine learning algorithm. An unsupervised algorithm is useful to detect common patterns, such as star-like relationship within the relationship graph. In this method, a subgraph matching algorithm and attribute hashing may be used. For example, components of the relationship graph may be hashed by the number of nodes, the number of edges, by user identification, by a transaction amount median, etc.

A supervised machine learning model may be built using input from subject matter experts to label a relationship graph having a known set of data as having edges corresponding to specific labels. For example, a subject matter expert may determine that certain edges are labeled with family relationships based on the subject matter expert's judgement. Once the supervised learning model is trained, the supervised learning model may then be applied to unknown data in a newly constructed relationship graph to predict relationship labels for the edges within a calculated degree of confidence.

Training the machine learning model may be an optional step, not shown in FIG. 2B. The machine learning model may be trained as follows. First, a relationship graph is accessed or provided for which the relationships between nodes are known. Next, the known data is converted into a vector format suitable for use by the machine learning model. Part of the data in that relationship graph is held back. The remaining portion of the data is provided to the machine learning model, and the machine learning model is instructed on what relationship labels apply to given nodes. Then, the held back data is provided to the machine learning model, but this time the relationship labels are also held back. The machine learning model then predicts the probabilities of relationship labels applying to the edges in the relationship graph for the held-back portion of the data. If the results are considered satisfactory compared to the actual relationship labels for the held-back data (i.e., the predicted relationship label probabilities are within threshold probabilities), then the machine learning model is considered “trained” and therefore available for use. If the results are not satisfactory, then either settings for the current machine learning model or changed, or a different machine learning model is selected. The process is then repeated. Once a satisfactory machine learning model is found, the satisfactory machine learning model is deemed “trained.”

At step 208C, the edges of the relationship graph are labeled based on the probabilities by the machine learning model in accordance with one or more embodiments. In this manner, many edges in the relationship graph can be labeled. The labeling may take different kinds of forms. For example, the labeling may be multi-class; that is, the machine learning model is considered to have a multi-class setting. In this case, the labels are mutually exclusive, and the machine learning output is the probability over classes or relationship types. In other words, a multi-class output is an output where each label is mutually exclusive and the output is expressed, for each edge, as a single relationship label having a highest probability relative to other possible relationship labels.

In another example, the labeling may be multi-label; that is, the machine learning model is considered to have a multi-label setting. In this case, multiple labels are allowed, and the machine learning output is multiple probabilities for multiple labels or relationship types. In other words, each edge may have multiple relationship type labels, with a corresponding probability associated with each relationship type label.

Outliers in the output may be useful for detecting fraud or security risks. For example, cyclic transactions are a strong indicator against money laundering, but multiple large, single transactions may be an indicator of some kind of fraud. Thus, for example, one of the relationship types possible for an edge may be “fraudulent” or “legitimate,” with an associated probability. Edges labeled as “fraudulent” may be flagged for a human to review, or an automatic security action can be taken upon detection of the fraudulent relationship, as described above.

FIG. 3 through FIG. 10 together depict a specific example of the one or more embodiments described above. Thus, FIG. 3 through FIG. 10 should be considered together. Where reference numerals are the same in FIG. 3 through FIG. 10, the same reference numerals refer to similar objects having similar definitions and uses. With that said, the specific example should not be limiting and be considered only illustrative of one embodiment of the invention.

In particular, FIG. 3 and FIG. 4 are tables that depict transactions between electronic accounts, in accordance with one or more embodiments. The table shown in FIG. 3 is raw financial transaction data in the form of financial transaction records retrieved from a financial management application for from bank records. The data types available are shown in the four columns: payer, payee, date, and amount. Thus, for example, as shown in row (300), user Tom transferred $200 to Account A on Feb. 22, 2019. Note that the relationships between the users (i.e., “Tom” and “Mike”) and/or their accounts (i.e., Account A, Account B, and Account C) are not shown.

FIG. 4, on the other hand, shows one possible result of applying the machine learning techniques described herein to the underlying data shown in FIG. 3. Namely, the table shows a probability that a particular type of relationship exists between a user and an account, and between the users “Tom” and “Mike.” For example, as shown in row (400), a relationship label has been applied to the first transaction from row (300) in FIG. 3. The relationship label is multi-label, indicating that an unknown user associated with Account A has an 80% chance of being a family member of user Tom, and has a 40% chance of being Tom's son. The process of how to automatically determine these relationship labels is described in greater detail with respect to FIG. 5 through FIG. 9.

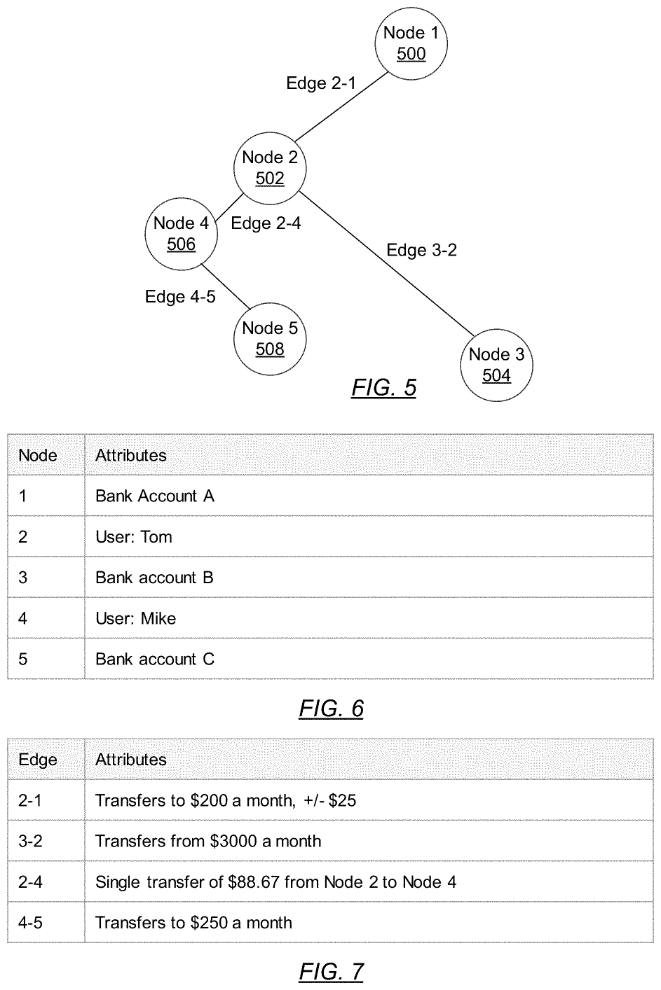

FIG. 5 through FIG. 7 should be read together. FIG. 5 shows a relationship graph constructed from the raw data shown in FIG. 3. FIG. 5 is a relationship graph having five nodes: Node 1 (500), Node 2 (502), Node 3 (504), Node 4 (506) and Node 5 (508). The lines connecting the nodes are the edges of the relationship graph. The table shown in FIG. 6 describes the attributes of each node in the relationship graph. The table shown in FIG. 7 describes the edges between the nodes in the relationship graph.

Continuing the above example, Node 1 (500) has the attributes “Bank Account A”, belonging to the unknown user. Node 2 (502) has the attributes “User Tom.” Edge (2-1) is relationship between these two nodes, and specifically the relationship is that Node 2 (502) transfers $200 about monthly, plus or minus $25, to Node 1 (500). The underlying data for establishing this relationship can be seen in FIG. 3. The remaining nodes and edges have attributes and edges as shown in FIG. 6 and FIG. 7, based on the underlying data shown in FIG. 3.

In this example, the nodes, edges, and corresponding attributes are converted into a vector suitable for use as input to a random forest unsupervised machine learning model, though note that many different machine learning models could have been used. The machine learning model is trained to calculate probabilities that a set of pre-defined relationships apply to any given edge. In this case, the machine learning model has a multi-label setting.

FIG. 8 and FIG. 9 should be read together. FIG. 8 shows an example of a relationship graph having labeled edges. FIG. 9 is the table that shows the labels for the edges in FIG. 8. Thus, for example, edge 2-1 in FIG. 8 corresponds to edge 2-1 in FIG. 9. The “labeling for edges among nodes” in FIG. 9 shows the labels for the edges in FIG. 8; thus, the label for edge 2-1 in FIG. 8 is “family member (80%), son (40%)”. Other labeling applies for edge 3-2, edge 2-4, and edge 4-5, as shown in FIG. 9.

The labels indicate that the random forest machine learning model applied to the graph of FIG. 5 calculated an 80% probability that Edge 2-1 can be labeled with the label “Family Member” and a 40% probability that Edge 2-1 can be labeled with the label “Son.” This information can then be used to generate the actionable electronic message (1000) shown in FIG. 10.

Attention is now turned to FIG. 10. The computer in this example is programmed to transmit the actionable electronic message (1000) when a particular relationship label can be applied to an edge above a specified probability threshold. For example, the computer is programmed to transmit the actionable electronic message (1000) over a network when one of the relationship labels is “family member” with a probability exceeding the threshold value of 75%. Thus, in this example, in response to detecting an 80% probability that Edge 2-1 is a family member relationship, the computer will automatically generate an actionable electronic message (1000).

To generate the actionable electronic message (1000), the computer may cross-reference other information that could have existed in the raw data shown in FIG. 3, or that existed in some other data source. For example, in this case, the computer is programmed to access an outside database which contains the identity and email address of the user associated with Account A shown in row (300) shown in FIG. 3 (also characterized as Node 1 (500) in FIG. 5 and FIG. 8).

The computer then takes the computerized action of creating the actionable electronic message (1000), filling in the name “Eric” for the “to” field (1002) and the phrase “Tom's son,” between the words “as” and “you” in the message field (1004). A computerized widget (1006), such as a button or hyperlink, is inserted into the email, thereby making the electronic message actionable. The computer then transmits the actionable electronic message (1000) to Eric's email address via a network as an email.

Once received, the recipient, Eric, can then use his user device to click on the computerized widget (1006). In response, Eric's user device will cause Eric's browser to navigate to a web page which shows an electronic offer to download or otherwise gain access to the same financial management application that Tom uses. Alternatively, the computerized widget (1006) could be used to grant Eric's user device access to the financial management application.

Thus, FIG. 10 shows an example of an automatic computer action that can then be taken based on relationship labels automatically discerned using machine learning combined with pre-defined rules or policies. A relationship graph is automatically built from financial transaction data, and then edges between nodes in the relationship graph are labeled by relationship type. The one or more embodiments thus address the technical challenge of using computers to automatically label the edges between the nodes by relationship type when the relationships are not explicitly described in the underlying financial transaction data. Specifically, a machine learning algorithm predicts relationship types based on relationship behavior inferred or predicted from the underlying financial transaction data. Thus, the one or more embodiments provide for a technical ability to automatically discern hidden relationships in underlying data and then act on those relationships. Actions, such as that shown in FIG. 10, can then be taken based on the discerned relationships, actions which otherwise could not have been taken automatically because the hidden relationships in the underlying data could not have been detected without using the one or more embodiments. Thus, the one or more embodiments provide the practical application of improving the use of a computer to detect hidden relationships and then taking newly available computerized actions accordingly.

Embodiments of the invention may be implemented on a computing system. Any combination of mobile, desktop, server, router, switch, embedded device, or other types of hardware may be used. For example, as shown in FIG. 11A, the computing system (1100) may include one or more computer processors (1102), non-persistent storage (1104) (e.g., volatile memory, such as random access memory (RAM), cache memory), persistent storage (1106) (e.g., a hard disk, an optical drive such as a compact disk (CD) drive or digital versatile disk (DVD) drive, a flash memory, etc.), a communication interface (1112) (e.g., Bluetooth interface, infrared interface, network interface, optical interface, etc.), and numerous other elements and functionalities.

The computer processor(s) (1102) may be an integrated circuit for processing instructions. For example, the computer processor(s) may be one or more cores or micro-cores of a processor. The computing system (1100) may also include one or more input devices (1110), such as a touchscreen, keyboard, mouse, microphone, touchpad, electronic pen, or any other type of input device.

The communication interface (1112) may include an integrated circuit for connecting the computing system (1100) to a network (not shown) (e.g., a local area network (LAN), a wide area network (WAN) such as the Internet, mobile network, or any other type of network) and/or to another device, such as another computing device.

Further, the computing system (1100) may include one or more output devices (1108), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1102), non-persistent storage (1104), and persistent storage (1106). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (1100) in FIG. 11A may be connected to or be a part of a network. For example, as shown in FIG. 11B, the network (1120) may include multiple nodes (e.g., node X (1122), node Y (1124)). Each node may correspond to a computing system, such as the computing system shown in FIG. 11A, or a group of nodes combined may correspond to the computing system shown in FIG. 11A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (1100) may be located at a remote location and connected to the other elements over a network.

Although not shown in FIG. 11B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (1122), node Y (1124)) in the network (1120) may be configured to provide services for a client device (1126). For example, the nodes may be part of a cloud computing system. The nodes may include functionality to receive requests from the client device (1126) and transmit responses to the client device (1126). The client device (1126) may be a computing system, such as the computing system shown in FIG. 11A. Further, the client device (1126) may include and/or perform all or a portion of one or more embodiments of the invention.

The computing system or group of computing systems described in FIGS. 11A and 11B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 11A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 11A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 11A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 11A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 11A and the nodes and/or client device in FIG. 11B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
receiving a data structure comprising data describing a plurality of transactions between electronic user accounts associated with a plurality of users;
constructing a relationship graph from the data in the data structure,
wherein the relationship graph comprises a plurality of nodes representing a plurality of entities described in the plurality of transactions, and
wherein the relationship graph further comprises a plurality of edges representing a plurality of connections between the plurality of nodes;
clustering groups of nodes within the plurality of nodes to form a plurality of clusters among the plurality of nodes; and
labeling the plurality of edges as a plurality of relationships types, by:
receiving, as input to a machine learning model, a vector comprising attributes representing the plurality of clusters, the plurality of nodes, and the plurality of edges;
outputting, from the machine learning model, a plurality of probabilities, wherein each of the plurality of probabilities corresponds to a corresponding probability that an edge in the plurality of edges represents a relationship type between two nodes in the plurality of nodes; and
labeling, based on the output, the plurality of edges as the plurality of relationship types.

2. The method of claim 1, further comprising:
responsive to a first entity in the plurality of entities having a first type of relationship label with respect to a second entity in the plurality of entities, transmitting an actionable electronic message to at least one of the first entity and the second entity.

3. The method of claim 2, wherein the actionable electronic message includes a hyperlink to a web page offering a product for sale.

4. The method of claim 3, wherein the product comprises a software product downloadable to a computing device of at least one of the first user and the second user.

5. The method of claim 1, further comprising:
responsive to a first entity in the plurality of entities having a first type of relationship label with respect to a second entity in the plurality of entities, taking a security action relative to at least one user account belonging to at least one of the first entity and the second entity.

6. The method of claim 1, wherein the security action comprises:
freezing electronic activity with respect to the at least one user account.

7. The method of claim 1, wherein the electronic user accounts comprise social media accounts, and wherein the method further comprises:
responsive to a first entity in the plurality of entities having a first type of relationship label with respect to a second entity in the plurality of entities, transmitting an actionable electronic message to a third entity in the plurality of entities.

8. The method of claim 7, wherein the third entity has an edge to the second entity but not the first entity, and wherein the actionable electronic message is an invitation to the third entity to establish an online social connection with the first entity.

9. The method of claim 1, wherein:
the plurality of entities comprises at least one of users or user accounts;
the plurality of nodes comprises the plurality of entities; and
the plurality of edges comprises a plurality of relationships established by a plurality of electronic transactions between the at least one of users or user accounts.

10. The method of claim 1, wherein:
the data structure comprises a table of financial transactions; and
the table comprises, for each node, a corresponding payer user_id, a corresponding payee user_id, a corresponding transaction date, and a corresponding transaction amount.

11. The method of claim 10, further comprising:
building the table of financial transactions from raw data stored by a financial management platform.

12. The method of claim 1, wherein clustering groups of entities further comprises:
extracting a sub-cluster within the relationship graph; and
using a measure of centrality within the sub-cluster to determine a position of an entity within the sub-cluster.

13. The method of claim 1, wherein:
the machine learning model comprises a deep learning unsupervised machine learning model; and
the output of the machine learning model comprises a multi-class setting where each label is mutually exclusive and the output is expressed, for each edge, as a single relationship label having a highest probability relative to other possible relationship labels.

14. The method of claim 13, wherein the output of the machine learning model comprises a multi-label setting where each edge is associated with a plurality of potential labels, wherein each of the plurality of potential labels has a corresponding probability.

15. A system comprising:
a computer processor;
a data repository storing:
a data structure comprising data describing a plurality of transactions between electronic user accounts associated with a plurality of users,
a relationship graph, wherein the relationship graph comprises a plurality of nodes representing a plurality of entities described in the plurality of transactions, and wherein the relationship graph further comprises a plurality of edges representing a plurality of connections between the plurality of nodes,
a plurality of clusters among the plurality of entities, and
a plurality of relationship types;
a graph generator executing on the computer processor and configured to build the relationship graph from the data in the data structure;
a cluster generator executing on the computer processor configured to cluster groups of entities within the plurality of entities to form the plurality of clusters among the plurality of entities; and
a machine learning model trained to label the plurality of edges according to the plurality of relationships types based on the plurality of clusters, the plurality of nodes, and the plurality of edges.

16. The system of claim 15, further comprising:
a message generating system executing on the computer processor and configured to generate and transmit an actionable electronic message to at least one of a first entity in the plurality of entities and a second entity in the plurality of entities, responsive to the first entity having a first type of relationship label with the second entity.

17. The system of claim 15, further comprising:
a security system executing on the computer processor and configured, responsive to a first entity in the plurality of entities having a first type of relationship label with a second entity in the plurality of entities, to take a security action relative to at least one user account belonging to at least one of the first entity and the second entity.

18. The system of claim 15, further comprising:
a relationship link generator executing on the computer processor and configured, responsive to a first entity in the plurality of entities having a first type of relationship label with a second entity in the plurality of entities, to transmit an actionable electronic message to a third entity in the plurality of entities.

19. The system of claim 15, wherein the cluster generator is configured to:
extract a sub-cluster within the relationship graph; and
use a measure of centrality within the sub-cluster to determine a position of an entity within the sub-cluster.

20. A method comprising:
receiving a data structure comprising data describing a plurality of transactions between electronic user accounts associated with a plurality of users;
constructing a relationship graph from the data in the data structure,
wherein the relationship graph comprises a plurality of nodes representing a plurality of entities described in the plurality of transactions, and
wherein the relationship graph further comprises a plurality of edges representing a plurality of connections between the plurality of nodes;
clustering groups of nodes within the plurality of nodes to form a plurality of clusters among the plurality of nodes; and
labeling the plurality of edges as a plurality of relationships types, by:
receiving, as input to a machine learning model, a vector comprising attributes representing the plurality of clusters, the plurality of nodes, and the plurality of edges;
outputting, from the machine learning model, a plurality of probabilities, wherein each of the plurality of probabilities corresponds to a corresponding probability that an edge in the plurality of edges represents a relationship type between two nodes in the plurality of nodes; and
labeling, based on the output, the plurality of edges as the plurality of relationship types; and
performing a computerized action based on the plurality of relationship types, the computerized action comprising one of: a computerized security action and electronic transmission of an electronically actionable message.
